(19) United States
(12) Patent Application Publication
(10) Pub. No.: US 2023/0343346 A1
(43) Pub. Date: Oct. 26, 2023

(54) QUANTIZATION AND ENTROPY CODING OF PARAMETERS FOR A LOW LATENCY AUDIO CODEC

(71) Applicant: Dolby Laboratories Licensing Corporation, San Francisco, CA (US)

(72) Inventors: David S. MCGRATH, Rose Bay (AU); Rishabh TYAGI, Sydney (AU); Stefanie BROWN, Lewisham (AU); Juan Felix Torres, Darlinghurst (AU)

(73) Assignee: Dolby Laboratories Licensing Corporation, San Francisco, CA (US)

(21) Appl. No.: 18/008,445

(22) PCT Filed: Jun. 10, 2021
(86) PCT No.: PCT/US2021/036886

§ 371 Date: Dec. 6, 2022

Related U.S. Application Data
(60) Provisional application No. 63/194,010, filed on May 27, 2021.
(60) Provisional application No. 63/037,784, filed on Jun. 11, 2020.

(51) Int. Cl. G10L 19/032; G10L 19/008

(52) U.S. Cl. CPC G10L 19/032; G10L 19/008

(57) ABSTRACT

Described is a method of frame-wise encoding metadata for an input signal, the metadata comprising a plurality of at least partially interrelated parameters calculable from the input signal. The method comprises, for each frame: iteratively performing, by using a looping process, steps of: determining a processing strategy from a plurality of processing strategies for calculating and quantizing the parameters; calculating and quantizing the parameters based on the determined processing strategy to obtain quantized parameters; and encoding the quantized parameters. In particular, each of the plurality of processing strategies comprises a respective first indication indicative of an ordering related to the calculation and quantization of individual parameters; and the processing strategy is determined based on at least one bitrate threshold.

### CROSS-REFERENCE TO RELATED APPLICATIONS

This application claims priority to U.S. Provisional Application Nos. 63/037,784 and 63/194,010, filed Jun. 11, 2020, and May 27, 2021, respectively, each of which is incorporated by reference in its entirety.

### TECHNICAL FIELD

The present disclosure is directed to the general area of entropy coding of parameters (side information) for low latency audio codecs (coders/decoders) and mechanisms to achieve parameter bit rate targets by iteratively refining the parameter bit rate using a range of quantization and entropy coding techniques.

### BACKGROUND

When the frame period (frame size) of an audio codec (coder/decoder) approaches 20 milliseconds (ms) or less, the audio essence is updated in short frame sizes. If one were to follow the approach of updating both the audio essence and parameters every frame, the side information for each frame would also be embedded and transmitted at the same rate.

However, it is generally known in the field that the side information does not need to be updated that frequently. For example, spatial parameters could be generally calculated and updated, e.g., every 40 ms. For codecs with frame periods of 40 ms or longer, this generally means that the parameter update rate is in line with the frame rate, and thus parameters could be encoded in each frame independently. However, in codecs with short frame periods, e.g., below 40 ms, this means that the parameters would be effectively oversampled if they are all included in each and every frame.

Thus, broadly speaking, the focus of this present disclosure is to propose mechanisms to minimize the side information (or sometimes also referred to as the parameters) as much as possible, yet to retain a high frame update rate for the audio essence.

### SUMMARY

In view of the above, the present disclosure generally provides a method of frame-wise encoding metadata for an input signal, as well as a corresponding program, computer-readable storage medium, and apparatus, having the features of the respective independent claims.

According to an aspect of the disclosure, a method of frame-wise encoding metadata for an input signal is provided. In particular, the metadata may be computed or calculated (e.g., extracted) from the input (audio or video) signal by using a suitable codec (coder/decoder). Generally speaking, the metadata may be used to regenerate the input signal at the decoder side. The metadata may comprise a plurality of at least partially interrelated parameters calculable from the input signal. That is to say, at least some of the parameters of the input signal may be calculated (e.g., generated or regenerated) in dependence on at least some of the other parameters, such that, depending on various circumstances, not all of the parameters have to be always transmitted in plain.

Particularly, the method may comprise/involve, for each frame, iteratively performing, by using a looping process, steps of: determining a processing strategy from a plurality of processing strategies for calculating and quantizing the parameters; calculating and quantizing the parameters based on the determined processing strategy to obtain quantized parameters; and encoding the quantized parameters. Since the looping process is generally directed to (among others) the processing related to the quantization, in some cases, the looping process may also be referred to as a quantization loop (or simply loop for short). In a similar manner, since the processing strategy is also generally directed to (among others) the processing related to the quantization, in some cases, the processing strategy may also be referred to as a quantization strategy (or, in some other cases, interchangeably as a quantization scheme). Further, it is to be noted that the encoding process may use any suitable coding procedure, including but is not limited to, entropy coding (e.g., Huffman or Arithmetic coding) or without entropy coding (e.g., base2 coding). Any other suitable coding mechanism may be adopted, depending on various implementations and/or requirements.

As can be understood and appreciated by the skilled person, the plurality of processing strategies for calculating and quantizing the parameters may be provided in any suitable manner, such as, predefined or preconfigured. Accordingly, the processing strategy may also be determined, from the plurality of processing strategies, in any suitable manner. For instance, depending on a (current) bitrate requirement, a suitable processing strategy may be selected out of the plurality of processing strategies, such that a resulting bitrate after performing the calculation, quantization and encoding (e.g., with or without entropy coding) based on the so selected processing strategy meets the (current) bitrate requirement. Notably, since the bitrate requirement may change from time to time (e.g., from frame to frame), the processing strategy so determined may also be different for each or some frames.

In particular, each one of the plurality of processing strategies may comprise a respective first indication that is indicative of an ordering (or a sequence) related to the calculation and quantization of individual parameters. That is to say, the first indication may comprise sequence information indicating when and in which order the individual parameters are calculated and quantized. As an example (but not as limitation), the first indication may comprise information indicating that all the parameters are calculated first before any of them are being quantized.

More particularly, the processing strategy is determined based on at least one bitrate threshold. As can be understood and appreciated by the skilled person, the bitrate threshold(s) may be for example predefined or preconfigured, depending on various implementations and/or requirements.

Configured as described above, broadly speaking, the proposed method of the present disclosure may be seen as introducing the concept of an iterative and stepwise approach to select an optimal parameter quantization scheme/strategy that generally searches for a ‘best’ (or optimal) quantization scheme from multiple alternatives. It is nevertheless to be noted that, in the present case, the term ‘best’ may not necessarily have to be the quantization scheme with the lowest (resulting) parameter bit rate (i.e., after quantization and possible encoding), but may be seen as one that could mitigate loss of state for the decoder. As can be understood by the skilled person, generally speaking, decoder “state” refers to the history of information that the decoder retains from previous frames in order to be able to correctly decode the current frame. For example (but not as limitation), in some cases, the encoder side may adopt a so-called time-differential encoding. However, the use of time-differential coding may generally exhibit the downside primarily in the fact that there is typically frame to frame state introduced which can present problems when, during transmission, the audio stream might undergo packet loss. In this case, both audio and parameters related to the audio may be lost during transmission, such that any parameters which have been updated with time-differential coding may experience multiple subsequent frames of potential artefacts. In this sense, the above-mentioned mitigation of loss of state is referring to an attempt of avoiding time-differential coding where possible, so that the decoder does not need to rely on metadata received in previous frames to decode the current frame’s metadata. And when time-differential coding is required, that it be done in such a way that the system recovers quickly from packet loss. Specifically, by carefully choosing an appropriate quantization scheme as described in the present disclosure, the above illustrated undesirable behavior relating to the packet loss can be limited (mitigated) as much as possible. Put differently, the present disclosure generally proposes an encode (encoder side) mitigation that involves an iterative selection process for the quantization and (with or without entropy) encoding which attempts to minimize the extent to which packet loss artefacts may be introduced for example because of the time-differential coding being used.

In some examples, the processing strategy may be determined such that a (resulting) bit rate of the encoded quantized parameters is equal to or less than the (metadata/parameter) bitrate threshold. As such, the resulting bitrate after quantization and coding using the determined (e.g., selected) processing strategy is within the (at least one) bitrate threshold, thereby meeting the bitrate requirement for example agreed upon beforehand or predetermined by a standardization specification.

In some examples, each of the plurality of processing strategies may further comprise a respective second indication indicative of information for performing the quantization of the parameters.

In some examples, the information for performing the quantization of the parameters comprises respective quantization ranges and/or quantization levels for the plurality of parameters. For example, the information may relate to maximum value, minimum value, number of quantization levels, or any other suitable value desired for each of the respective parameters (e.g., a respective one per parameter type). Generally speaking, as can be understood and appreciated by the skilled person, these quantization related values/parameters provide or define coarser or finer quantization overall, and correspondingly accompanying better or worse spatial reproduction. As can be understood and appreciated by the skilled person, broadly speaking, some (quantization) parameters are generally considered to be more sensitive to quantization than others, and there may generally not be an absolute fine/coarse quantization methodology for all parameters.

Configured as above, the plurality of processing strategy may be seen as each comprising a first (part/portion of) indication with regard to the ordering/sequence relating to the calculation and quantization; and a second (part/portion of) indication with regard to the actual quantization process. By carefully designing the processing strategy (e.g., different combinations of first indication and second indication), various bitrate configurations/requirements may be targeted for example for different use cases or scenarios, in an efficient and flexible manner. Specifically, in some cases, there may exist one processing strategy (e.g., the coarsest quantization strategy among the plurality of quantization strategies) that may be considered to be guaranteed to be less than (or equal to) the target bitrate threshold.

In some examples, the encoding of the parameters may involve time- and/or frequency-differential coding. Broadly speaking, a single metadata parameter may be quantized from a continuous numerical value to an index representing a discrete value. In non-differential coding, the information that is coded for that metadata parameter corresponds directly to that index. Notably, the term “non-differential coding” used in the present disclosure may refer to non time-differential coding, non frequency-differential coding, or non-differential coding of all kinds as appropriate, as will be understood and appreciated by the skilled person. In time-differential coding, the information that is coded is the difference between the index of that metadata parameter from the current frame, and the index of the same metadata parameter from the previous frame. As will be understood and appreciated by the skilled person, the above illustrated general concept of time-differential coding may be further extended, e.g., to a plurality of frequency bands. Accordingly, the metadata parameter may be extended similarly, e.g., to a plurality of parameters respectively corresponding to (each of) the plurality of frequency bands, as appropriate. Frequency-differential coding follows a similar principle, but the coded difference is between one frequency band’s metadata of the current frame and another frequency band’s metadata of the current frame (as opposed to the current frame minus the previous frame in time-differential coding). As a simple example (but not as limitation), assuming a0, a1, a2 and a3 to denote parameters indices in 4 frequency bands of a particular frame, then, in one example implementation, the frequency-differential indices can be a0, a0-a1, a1-a2, a2-a3. As will be appreciated by the skilled person, the general idea behind the (time- and/or frequency-) differential coding is that metadata may typically change slowly from frame to frame, or from frequency-band to frequency-band, so that even if the original value of the metadata was large, the difference between it and the previous frame’s metadata, or difference between it and other frequency band’s metadata, would likely be small. This is advantageous because, generally, parameters with statistical distributions that tend towards zero can be coded using fewer bits.

In some examples, the processing strategy determined for a current frame may be different from the processing strategy determined for a previous frame, and accordingly, the encoding of the parameters may involve time-differential coding across the different processing strategies. That is to say, in certain cases where different processing strategies are determined (e.g., for different frames of the input signal), the method of the present disclosure is still able to encode the parameters, for example by involving time-differential coding across those different processing strategies.

As indicated above, the plurality of processing strategies may each comprise a respective first indication that is indicative of an ordering (or a sequence) related to the calculation and quantization of individual parameters.

In some examples, the first indication may comprise information indicating that all of the parameters are calculated before being quantized.

In some examples, the first indication may comprise information indicating that the parameters are individually calculated and then quantized one after another in sequence. In particular, at least one parameter of the plurality of parameters may be calculated based on another quantized parameter of the plurality of parameters. As an example but not as limitation, assuming in total three parameters to be calculated and quantized, then the first parameter may be calculated first (from the input signal) and then quantized; while the second parameter may be calculated based on the (quantized) first parameter and then the second parameter itself is quantized; and finally, the third parameter is calculated based on the (quantized) first parameter and/or the (quantized) second parameter, and then quantized. In one example, the third parameter is calculated based on the quantized first and second parameters.

In some examples, the first indication may comprise information indicating that all of the parameters are calculated before any parameter is quantized; and particularly, at least one of the parameters is recalculated, based on another quantized parameter, and the recalculated parameter is quantized. Still taking the above assumption of three parameters as an example, all the parameters are calculated first, and then the first and second parameters are quantized; afterwards, the third parameter is recalculated, e.g., based on the quantized second parameters, and then the third parameter is quantized based on the recalculated value.

In some examples, the method may further comprise, before encoding the quantized parameters, mapping indices of the quantized parameters from the previous frame to that of the current frame. In other words, if a different processing strategy (quantization scheme, e.g., in terms of different quantization levels and/or sequences) is determined (e.g., selected/chosen), (quantization) indices from the previous frame that were quantized with a different quantization scheme are mapped to those of the current frame. Notably, this allows time-differential coding between frames without resorting to having to send a non-differential frame each time quantization scheme is changed, thereby further improving the overall coding efficiency and flexibility.

In some possible implementations, the mapping of the indices may be performed based on a formulae: index_{cur} = round(indexₚᵣₑᵥ × (quant_lvl_{cur} - 1)/(quant_lvlₚᵣₑᵥ - 1)), wherein index_{cur} is the indices of the current frame after mapping, indexₚᵣₑᵥ is the index of the previous frame, quant_lvl_{cur} is the quantization level of the current frame and quant_lvlₚᵣₑᵥ is the quantization level of the previous frame.

As a simple illustrative example, let the quantization range be 0 to 2, and let the previous quantization levels be 11. In the case of uniform quantization, this would generally mean that each quantization step would be 0.2. Further, let the current quantization levels be 21, which means that each quantization step is 0.1 with uniform quantization. Based on these assumptions, if a quantized value in the previous frame was 0.4, then with 11 uniform quantization levels, one would get the following previous index indexₚᵣₑᵥ = 2. The mapping provides the quantized indices of the previous frame’s metadata as if it were quantized using the current frame’s quantization levels. Thus, in this example, if the quantization levels in the current frame are 21, then the quantized value 0.4 would be mapped to index_{curr} = 4. Once mapped indices are computed, the difference between the current frame and previous frame indices is calculated, and this difference is encoded. Analogous or similar approaches may also be applied to the frequency-differential coding, if needs be, as will be understood and appreciated by the skilled person.

It is to be noted that the above formulae and the respective example are merely provided for illustrative purpose only, any other suitable mechanism (e.g., a lookup table, etc.) may be adopted for performing the mapping of indices, as will be understood and appreciated by the skilled person.

In some examples, the at least one bitrate threshold may comprise a target bitrate threshold. Accordingly, the looping process may involve steps of: quantizing and encoding the parameters in a non-differential and/or frequency-differential manner with an entropy coder in accordance with the (determined) processing strategy; estimating (e.g., calculating) a first parameter bitrate for the encoded parameters; and if the first parameter bitrate is less than or equal to the target bitrate threshold, exiting the looping process. Particularly, in some possible implementations, the first parameter bitrate may be estimated (calculated) from the minimum of the non-differential and the frequency-differential coding schemes coded with (trained) entropy coders. As will be understood and appreciated by the skilled person, the entropy coders may be trained in any suitable manner, e.g., in order to be adapted to individual coding schemes. For instance, in some possible implementations, the training of the entropy coders may involve developing probability models based on metadata calculated from a large set of input signals. The particular signals chosen for developing these models are expected to be representative of the types of signals expected to be passed through the system in everyday use. As such, metadata from other similar signals ought to be encoded as efficiently as possible. In short, generally speaking, this training is about adapting the entropy coders to have maximum efficiency with the expected probability distribution of the parameters.

In some examples, the looping process may further involve steps of: if the first parameter bitrate is larger than the target bitrate threshold, quantizing and encoding the parameters in a non-differential manner with no entropy in accordance with the processing strategy; estimating a second parameter bitrate for the encoded parameters; and if the second parameter bitrate is less than or equal to the target bitrate threshold, exiting the looping process.

In some examples, the looping process may further involve steps of: if the second parameter bitrate is larger than the target bitrate threshold, quantizing and encoding the parameters in a time-differential manner with the (trained) entropy coder in accordance with the processing strategy; estimating a third parameter bitrate for the encoded parameters; and if the third parameter bitrate is less than or equal to the target bitrate threshold, exiting the looping process.

In some examples, the time-differential quantization and encoding may be performed on a subset of the parameters in a frequency interleaved manner with respect to a previous frame. Particularly, as can be understood and appreciated by the skilled person, the frequency interleaved manner may generally refer to cases where different frequency bands (e.g., corresponding to different subsets of parameters) are processed (e.g., quantized and encoded) for different frames. In other words, the time-differential quantization and encoding of (at least a subset of) the parameters for the current frame may be performed in a different frequency band (corresponding to the presently processed parameters) that is different from that of the previous frame.

In some examples, the time-differential quantization and encoding may be performed by cycling through a number of frequency interleaved time-differential coding schemes, in such a manner that, for each cycle, a different subset of the parameters (corresponding to a different set of frequency bands) is quantized and encoded time-differentially while the rest parameters are quantized and encoded non-differentially.

In some examples, the determined processing strategy may be considered as a first processing strategy, and accordingly the looping process may further involve steps of: if the third parameter bitrate is larger than the target bitrate threshold, determining, from the plurality of processing strategies, a second processing strategy, such that a (resulting) bitrate by applying the second processing strategy would expected to be less than that of using the first processing strategy; and repeating the above steps of the looping process. As can be understood and appreciated by the skilled person, in such cases, the so determined (e.g., selected) second processing strategy may be simply considered as a processing strategy that is coarser than the previously determined (e.g., selected) first processing strategy. As such, the set of possible quantized values/indices may be reduced in size, thereby (typically) resulting in a correspondingly also reduced bitrate.

In some examples, the parameters may be represented in a first number of frequency bands, and the looping process may further involve steps of: if the third parameter bitrate is larger than the target bitrate threshold, reducing the number of frequency bands representing the parameters to a second number smaller than the first number, such that a total number of the parameters to be quantized and encoded is reduced; and repeating the above steps of the looping process.

In some examples, the parameters are represented in a first number of frequency bands, and the looping process may further involve steps of: if the third parameter bitrate is larger than the target bitrate threshold: reusing (or, in some cases, referred to as “freezing”) parameters in one or more frequency bands from the previous frame in the current frame; and repeating the steps of the above looping process. As an example, when encoding with a specific coding scheme, one can freeze parameters in certain frequency band(s) (e.g., frequency bands 2, 6, and 10). As a further illustrative example, if one is freezing all frequency bands over a period of 2 frames, then the encoder can send half of the bands (e.g., the even numbered bands) in frame N and remaining half (e.g., the odd numbered bands) in frame N+1 (thereby reducing the total number of parameters to be sent), which generally means that the decoder will get all (e.g., 12) updated frequency bands every other frame. In such cases, if one frame is lost, there is generally the option of extrapolating from the last two good frames. When recovering from packet loss, it is possible to interpolate between the bands that were received with a given frame. Generally speaking, the result of the above freezing process would be reduced entropy, requiring no change to the decoder or the entropy coding scheme, with a slight impact to quality.

Summarizing, when it comes to reducing the total number of bands, this can be done in at least the following two ways. The first way is reducing the frequency resolution, wherein instead of using N bands, only M bands (where M < N) are used, and the bandwidth of one or more bands in the M band configuration is higher than the N band configuration. These M bands may be derived from N bands, for example adjacent bands could be grouped together either in pairs, threes, etc., or any other grouping that has perceptual relevance. The second way is reducing temporal resolution, wherein the band widths of all N bands can remain exactly the same in the frequency domain but bands are frozen over a period of x frames (where x > 1). This means that updates to N bands can be sent over a period of x frames, or in other words, only N/x bands out of N bands need to be updated and sent to the decoder with each frame.

In some examples, at least one bitrate threshold may further comprise, in addition to the above illustrated target bitrate threshold, a maximum bitrate threshold larger than the target bitrate threshold. Accordingly, the looping process may further involve steps of: before determining the second processing strategy, or reducing the number of frequency bands, or reusing the parameters, obtaining a minimum of the first, second and third parameter bitrates; and if the minimum is less than or equal to the maximum bitrate threshold, exiting the looping process.

It may be worthwhile to note that, if the processing loop exits at a specific step as illustrated above, this would generally mean that the final parameter bitrate is the bitrate that is computed at that step (i.e., when exiting the processing loop). Furthermore, as noted above, to be on the safest side, there may exist a certain (e.g., coarsest) quantization strategy in the given quantization strategies available to quantize the parameters that is guaranteed to be less than (or equal to) the target bitrate threshold or the maximum bitrate threshold. As such, it can be ensured that there is always a solution for fitting parameter bitrate within the target bitrate threshold or the maximum bitrate threshold.

In some examples, the parameters may comprise one or more of prediction parameters (sometimes simply referred to as PR parameters), cross-prediction parameters (sometimes simply referred to as C parameters), and decorrelation parameters (sometimes simply referred to as P parameters). As indicated above, at least some of the parameters are at least partially interrelated, such that they may be calculated based on one another. Of course, as can be understood and appreciated by the skilled person, any other suitable (types of) parameters may exist, depending on various implementations and/or requirements (e.g., the specific codecs being used).

As indicated above, the ordering (or sequence) of the calculation and quantization of the parameters may be indicated by the first indication of the processing strategies.

In some examples, the prediction parameters may be calculated and quantized first, the cross-prediction parameters are calculated from the quantized prediction parameters and then quantized, and the decorrelation parameters are first calculated from the quantized cross-prediction parameters and the quantized prediction parameters, and then quantized.

In some examples, the parameters (i.e., the prediction parameters, cross-prediction parameters, and decorrelation parameters) may be first calculated, then the decorrelation parameters and the prediction parameters are quantized, and, from the quantized prediction parameters, the cross-prediction parameters are recalculated and then quantized.

In some examples, the method may be applied to metadata encoding of an immersive voice and audio services (IVAS) codec or an Ambisonics codec. The Ambisonics codec may be a first order Ambisonics (FOA) codec or even higher order Ambisonics (HOA) codec. Of course, as will be understood and appreciated by the skilled person, any other suitable codecs may be applied thereto, depending on various implementations.

In some examples, the frame size is less than 40 ms, and in particular, is equal to or less than 20 ms.

According to another aspect of the disclosure, an apparatus including a processor and a memory coupled to the processor is provided. The processor may be adapted to cause the apparatus to carry out all steps of the example methods described throughout the disclosure.

According to a further aspect of the disclosure a computer program is provided. The computer program may include instructions that, when executed by a processor, cause the processor to carry out all steps of the example methods described throughout the disclosure.

According to a yet further aspect, a computer-readable storage medium is provided. The computer-readable storage medium may store the aforementioned computer program.

It will be appreciated that apparatus features and method steps may be interchanged in many ways. In particular, the details of the disclosed method(s) can be realized by the corresponding apparatus (or system), and vice versa, as the skilled person will appreciate. Moreover, any of the above statements made with respect to the method(s) are understood to likewise apply to the corresponding apparatus (or system), and vice versa.

### BRIEF DESCRIPTION OF DRAWINGS

Example embodiments of the disclosure are explained below with reference to the accompanying drawings, wherein

FIG. 1 is a schematic illustration of a block diagram of a coder/decoder (“codec”) for encoding and decoding signals (bitstreams) according to an embodiment of the present disclosure,

FIG. 2 is a flowchart illustrating an example of a method of frame-wise encoding metadata for an input signal according to an embodiment of the disclosure,

FIG. 3 is a flowchart illustrating an example of a processing loop according to an embodiment of the disclosure, and

FIG. 4 is a flowchart illustrating an example of a processing loop according to another embodiment of the disclosure.

### DETAILED DESCRIPTION

The Figures (Figs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Furthermore, in the figures, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths, as may be needed, to affect the communication.

As indicated above, when the frame period of an audio codec (coder/decoder) approaches 40 ms, or even 20 ms, or less, the audio essence may be updated in short time intervals. But it is generally known that the side information (or metadata/parameter) does not need to be updated that frequently. Put differently, in codecs with short frame periods, it may generally mean that parameters would be oversampled if they were all included in every frame (as is the audio signal). In some implementations, it may be possible to not send metadata every frame, and only update it every M-th frame (e.g., up to M = 4 in some cases). This would generally lower the average metadata bitrate.

In view thereof, broadly speaking, the application of the technique as described in the present application may apply to any parameters or side information in audio coding where temporal correlation of parameters exceeds the stride of the codec. For example (but not as limitation), the procedures of frequency interleaved time-differential entropy coding could apply to parameters in the immersive voice and audio services (IVAS) codec as standardized by the 3rd Generation Partnership Project (3GPP) that model spatial interactions or any parametric stereo coding technique that attempts to minimize codec stride below 40 msec. However, as will be understood and appreciated by the skilled person, while the embodiments of the present disclosure may be applied to an immersive first order Ambisonics (FOA) codec, the approach described herein is generally applicable to any other suitable audio codec (e.g., higher order Ambisonics, HOA, codecs) where the stride or frame size is small which would generally present some specific challenges in encoding side information in a timely manner as mentioned above.

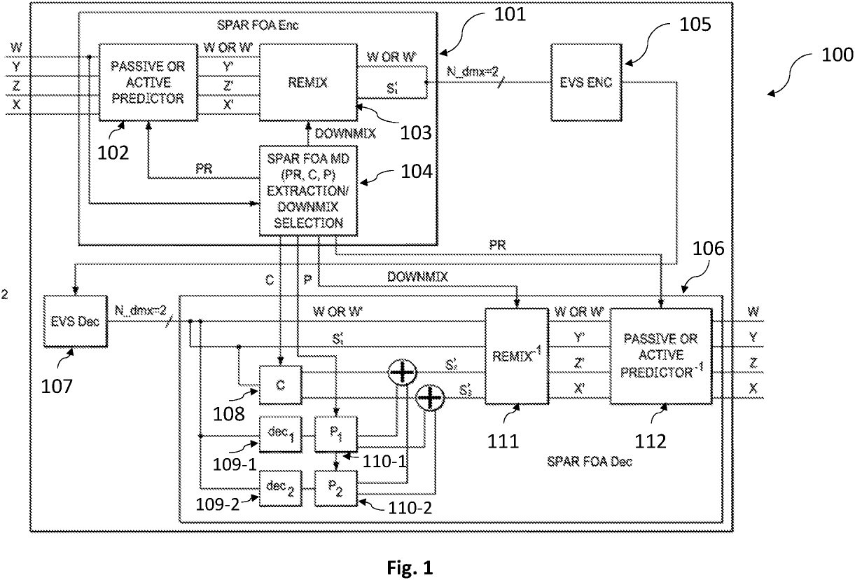

Referring now to FIG. 1, a schematic illustration of a (simplified) block diagram of a coder/decoder (“codec”) 100 for encoding and decoding signals (bitstreams) according to an embodiment of the present disclosure is shown. Particular, as can be understood by the skilled person, the illustrative example of FIG. 1 shows a spatial reconstructor (SPAR) first order Ambisonics (FOA) codec 100 for encoding and decoding IVAS bitstreams in FOA format. More specifically, as indicated in the figure, the FOA codec 100 of FIG. 1 involves both passive and active prediction, as can be understood and appreciated by the skilled person.

Generally speaking, for encoding, an IVAS encoder may include spatial analysis and downmix unit that receives audio data, including but not limited to: mono signals, stereo signals, binaural signals, spatial audio signals (e.g., multi-channel spatial audio objects), FOA, higher order Ambisonics (HOA) and any other suitable audio data. In some implementations, the spatial analysis and downmix unit may implement complex advanced coupling (CACPL) for analyzing/downmixing stereo/ FOA audio signals and/or SPAR for analyzing/downmixing FOA audio signals. In other implementations, the spatial analysis and downmix unit may also implement any other suitable formats.

Now referring back to FIG. 1, the FOA codec 100 may include a SPAR FOA encoder 101, an enhanced voice services (EVS) encoder 105, a SPAR FOA decoder 106 and a EVS decoder 107. The SPAR FOA encoder 101 may be configured to convert a FOA input signal into a set of downmix channels and parameters used to regenerate the input signal at the SPAR FOA decoder 106. Depending on various implementations, the downmix signals may vary from 1 to 4 channels and the parameters (or sometime also referred to as coefficients) may include, but is not limited to, prediction coefficients (PR), cross-prediction coefficients (C), and decorrelation coefficients (P). Note that SPAR is a process used to reconstruct an audio signal from a downmix version of the audio signal using the PR, C and P parameters, as will be described in further detail below.

Depending on the number of the downmix channels, one of the FOA inputs may be always sent intact (e.g., the W channel as shown in the present example of FIG. 1), and 1 to 3 other channels (e.g., the Y, Z, and X channels as shown in the present example of FIG. 1) may either be sent as residuals, or completely parametrically.

In particular, the prediction parameters may remain the same regardless of the number of downmix channels, and can be used to minimize predictable energy in the residual downmix channels. On the other hand, the cross-prediction parameters may be used to further assist in regenerating fully parametrized channels from the residuals. As such, these parameters would not be required in the 1 and 4 channel downmix cases, where there are no residual channels to predict from in the former case, and no parameterized channels to predict in the latter. Furthermore, the decorrelator parameters may be used to fill in the remaining energy not accounted for by the prediction and cross-prediction. Again, the number of decorrelation parameters may be dependent on the number of downmix channels in each band.

The example of FIG. 1 generally shows an illustrative embodiment of such a system and how these parameters fit in at the decoder side. Particularly, the example implementation shown in FIG. 1 depicts a nominal 2-channel downmix, where the representation of W (being W for passive prediction or W′ for active prediction) channel is sent unmodified with a single predicted channel Y′ to the decoder 106. The cross-prediction coefficients (C) allow at least some portion of the parametric channels to be reconstructed from the residual channels, in the cases where at least one channel sent as a residual and at least one is sent parametrically, i.e., for 2 and 3 channel downmixes. Thus, generally speaking, for two channel downmixes, the C parameters allow some of the X and Z channels to be reconstructed from Y′, and the remaining channels are reconstructed by decorrelated versions of the W channel, as described in further detail below. In the 3 channel downmix case, the residual Y′ and X′ channels are used to reconstruct Z alone.

Notably, as will also be understood and appreciated by the skilled person, in some exemplary implementations, W can be an active channel (or in other words, with active prediction, hereinafter referred to as W′). As an example (but not as limitation), an active W channel that allows some kind of mixing of the X, Y, Z channels into the W channel may be defined as follows:

$${\text{W}}^{′} = \text{W} + \text{f} ∗ {\text{pr}}_{y} ∗ \text{Y} + \text{f} ∗ {\text{pr}}_{\text{z}} ∗ \text{Z} + \text{f} ∗ {\text{pr}}_{\text{X}} ∗ \text{X} \qquad \text{(1)}$$

where f is a suitable constant (e.g., 0.5) that allows mixing of at least some of the X, Y, Z channels into the W channel; and pr_{y}, prₓ and pr_{z} are the prediction (PR) coefficients. Accordingly, in cases of passive W, f = 0 so there would be no mixing of X, Y, Z channels into the W channel.

In the example implementation of FIG. 1, the SPAR FOA encoder 101 may include a (passive or active) predictor unit 102, a remix unit 103 and an extraction/downmix selection unit 104. Particularly, the predictor 102 may receive the FOA channels in a 4-channel B-format (W, Y, Z, X) and computes downmix channels (representation of W, Y′, Z′, X′).

The extraction/downmix selection unit 104 may extracts the SPAR FOA metadata for example from a metadata payload section of the IVAS bitstream. The predictor unit 102 and the remix unit 103 may then use the SPAR FOA metadata to generate the remixed FOA channels (representation of W, S₁′, S₂′and S₃′), which may then be input into the EVS encoder 105 to be encoded into an EVS bitstream, which may be subsequently encapsulated in the IVAS bitstream sent to the decoder 106.

Referring to the SPAR FOA decoder 106, the EVS bitstream is decoded by the EVS decoder 107 resulting in a number of (e.g., N_dmx = 2, where N_dmx denotes the number of downmix channels) downmix channels. In some implementations, the SPAR FOA decoder 106 may be configured to perform a reverse of the operations that have been performed by the SPAR encoder 101. For instance, in the example of FIG. 1 the remixed FOA channels (representation of W, S₁′, S₂′and S₃′) may be recovered from the 2 downmix channels using the SPAR FOA spatial metadata. The remixed SPAR FOA channels may then be input into the inverse mixer 111 to recover the SPAR FOA downmix channels (representation of W, Y′, Z′ and X′). Subsequently, the predicted SPAR FOA channels may then be input into the inverse predictor 112 to recover the original unmixed SPAR FOA channels (W, Y, Z and X).

Note that in this two-channel example, the decorrelator blocks 109-1 (dec₁) and 109-2 (dec₂) may be used to generate decorrelated versions of the W channel using a time domain or frequency domain decorrelator. The downmix channels and decorrelated channels may be used in combination with the SPAR FOA metadata to reconstruct parametrically the X and Z channels. The C block 108 may refer to the multiplication of the residual channel by the 2×1 C coefficient matrix, thereby creating two cross-prediction signals that may be summed into the parametrically reconstructed channels, as shown in the example of FIG. 1. Moreover, the P₁ block 110-1 and P₂ block 110-2 may refer to multiplication of the decorrelator outputs by columns of the 2x2 P coefficient matrix, thereby creating four outputs that can be summed into the parametrically reconstructed channels, as shown in the example of FIG. 1.

As noted above, in some implementations, depending on the number of downmix channels, one of the FOA inputs may be sent to the SPAR FOA decoder 106 intact (e.g., the exemplary W channel), and one to three of the other channels (Y, Z, and X) may either be sent as residuals or completely parametrically to the SPAR FOA decoder 106. The PR coefficients, which remain the same regardless of the number of downmix channels N_dmx, may be used to minimize the predictable energy in the residual downmix channels. The C coefficients may be used to further assist in regenerating fully parametrized channels from the residuals. As such, the C coefficients may not be required in the one and four channel downmix cases, where there would be no residual channels or parameterized channels to predict from. The P coefficients are used to fill in the remaining energy not accounted for by the PR and C coefficients. The number of P coefficients is generally dependent on the number of downmix channels N in each band.

In some implementations, SPAR PR coefficients (Passive W only) are calculated as follows:

Step 1. Predict all side signals (Y, Z, X) from the main W signal using a prediction matrix comprised of the prediction coefficients as follows:

$$\left[\begin{matrix}W \\ {Y}^{′} \\ {Z}^{′} \\ {X}^{′}\end{matrix}\right] = \left[\begin{matrix}1 & 0 & 0 & 0 \\ - p {r}_{Y} & 1 & 0 & 0 \\ - p {r}_{Z} & 0 & 1 & 0 \\ - p {r}_{X} & 0 & 0 & 1\end{matrix}\right] \left[\begin{matrix}W \\ Y \\ Z \\ X\end{matrix}\right] \qquad \text{(2)}$$

where, as an example, the prediction parameter for the predicted channel Y′ may be calculated as:

$$p {r}_{Y} = \frac{{R}_{Y W}}{max \left({R}_{W W} , ∈\right)} \frac{1}{max \left(1 , \sqrt{{\left|{R}_{Y Y}\right|}^{2} + {\left|{R}_{Z Z}\right|}^{2} + {\left|{R}_{X X}\right|}^{2}}\right)} \qquad \text{(3)}$$

where R_{AB} = cov(A, B) are elements of the input covariance matrix corresponding to signals A and B, and can be computed per band. Similarly, the Z′ and X′ residual channels have corresponding prediction parameters, namely pr_{z} and prₓ. The matrix above is known as the prediction matrix.

Step 2. Remix the W and predicted (Y′, Z′, X′) signals from most to least acoustically relevant, wherein “remixing” means reordering or re-combining signals based on some methodology,

$$\left[\begin{matrix}W \\ {S}_{1} {}^{′} \\ {S}_{2} {}^{′} \\ {S}_{3} {}^{′}\end{matrix}\right] = \left[r e m i x\right] \left[\begin{matrix}{W}^{′} \\ {Y}^{′} \\ {Z}^{′} \\ {X}^{′}\end{matrix}\right] \qquad \text{(4)}$$

One possible implementation of remixing is re-ordering of the input signals to W, Y′, X′ and Z′, given the assumption that audio cues from left and right are more acoustically relevant or important than the front-back, and the front-back cues are more acoustically relevant/important than the up-down cues.

Step 3. Calculate the covariance of the 4 channel post-prediction and remixing downmix as:

$${R}_{p r} = \left[r e m i x\right] \left[p r e d i c t i o n\right] . R . {\left[p r e d i c t i o n\right]}^{H} {\left[r e m i x\right]}^{H} , \qquad \text{(5)}$$

where [prediction] and [remix] matrices refer to those used in equations (2) and (4) respectively. The final post-prediction and remixing downmix matrix can be written as

$${R}_{p r} = \left(\begin{matrix}{R}_{W W} & {R}_{W d} & {R}_{W u} \\ {R}_{d W} & {R}_{d d} & {R}_{d u} \\ {R}_{u W} & {R}_{u d} & {R}_{u u}\end{matrix}\right) \qquad \text{(6)}$$

where d represents the residual channels (i.e., the 2nd to N_dmx channels, wherein N_dmx denotes the number of the downmix channels), and u represents the parametric channels that need to be wholly regenerated (i.e., the (N_dmx+1)th to 4th channels).

For the example of a WS₁S₂S₃ downmix with 1 to 4 channels, d and u may represent the following channels shown in Table 1:

TABLE 1

d and u channel representations

| N | d channels | u channels |
|---|---|---|
| 1 | -- | S₁′, S₂′, S₃′ |
| 2 | S₁′ | S₂′, S₃′ |
| 3 | S₁′, S₂′ | S₃′ |
| 4 | S₁′, S₂′, S₃′ | -- |

Of main interest to the calculation of SPAR FOA metadata are the R_{dd}, R_{ud} and Rᵤᵤ quantities.

Step 4. From the R_{dd}, R_{ud} and Rᵤᵤ quantities, the codec 100 may determine if it is possible to cross-predict any remaining portion of the fully parametric channels from the residual channels being sent to the decoder. In some possible implementations, the required extra C coefficients may be calculated as:

$$C = {R}_{u d} {\left({R}_{d d} + I max \left(ε , t r \left({R}_{d d}\right) ∗ 0.005\right)\right)}^{- 1} . \qquad \text{(7)}$$

Therefore, the C parameter would generally have the shape (1×2) for a 3-channel downmix, and (2×1) for a 2-channel downmix.

Step 5. Calculate the remaining energy in parameterized channels that must be reconstructed by decorrelators 109-1 and 109-2 as:

$$R e {g}_{u u} = C {R}_{d d} {C}^{H} \qquad \text{(8)}$$

$$R e {s}_{u u} = {R}_{u u} - R e {g}_{u u} \qquad \text{(9)}$$

$$P = \sqrt{\frac{R e {s}_{u u}}{max \left(ε , {R}_{W W} , α ∗ t r \left(\left|R e {s}_{u u}\right|\right)\right)}} \qquad \text{(10)}$$

where 0 ≤ α ≤ 1 is a constant scaling factor. Notably, the residual energy in the upmix channels Resᵤᵤ is the difference between the actual energy Rᵤᵤ (post-prediction) and the regenerated cross-prediction energy Regᵤᵤ.

In some possible implementations, the matrix square root may be taken after the normalized Resᵤᵤ matrix has had its off-diagonal elements set to zero. P may also be a covariance matrix, and hence may be Hermitian symmetric. Thus only the parameters from the upper or lower triangle need be sent to decoder 106. The diagonal entries may be real, while the off-diagonal elements may be complex. In some further possible implementations, the P coefficients can be further separated into diagonal and off-diagonal elements P_{d} and Pₒ, respectively. In some implementations, only the diagonal elements of P are computed and sent to the decoder, and these may be calculated as follows:

$$P = \sqrt{\frac{d i a g \left(R e {s}_{u u}\right)}{max \left(ε , {R}_{W W} , α ∗ t r \left(\left|R e {s}_{u u}\right|\right)\right)}}$$

Now, at the encoder side, the quantization of these parameters may become necessary. Particularly, given the dependencies between the three parameter types (i.e., PR, C and P) as indicated above, the ordering (or sequence) of their calculation and quantization may thus be generally considered to be important for the audio quality. According to the present disclosure, three possible embodiments of methods to achieve this may be as follows:

### 1. All-in-One

In this embodiment, the decorrelators are generally not allowed to make up for quantized prediction errors.

To be more specific, in a first step, the parameters PR, then C, and then P are calculated as illustrated above without quantization. Then, the parameters PR, C and P are all quantized, according to a quantization strategy or scheme (e.g., based on suitable quantization ranges and/or quantization levels, as will be understood by the skilled person).

### 2. Cascade

Generally speaking, this particular embodiment allows accurate prediction and cross-prediction, and the decorrelators may fill in the errors from quantization.

To be more specific, in a first step, the parameter PR is calculated and then quantized. Subsequently, from the quantized PR parameters, the parameter C is calculated then quantized. Finally, from the quantized C parameters, the parameter P is also calculated and then quantized.

### 3. Partial Cascade

Generally speaking, this particular embodiment would minimize the P coefficients, thereby allowing accurate cross-prediction but without allowing decorrelators to make up for prediction errors.

To be more specific, in a first step, the parameters PR, C and P are calculated without quantization as in the above All-in-one embodiment, then the P parameter is quantized. Subsequently, the PR parameters are also quantized. And finally, from the quantized PR parameters, the C parameter is recalculated and then quantized.

In each of the above illustrated embodiments, the downmix (including residuals) may always be calculated with the quantized prediction coefficients.

As can be understood and appreciated by the skilled person, the quantization process itself may be defined by a suitable (quantization) range. For instance, a range of [-a, a] may be defined for some parameters (e.g., the parameters PR, C and off diagonal elements of P), whilst another range of [0, a] may be defined for others. Further, a number of quantization levels may also be defined that should be spread uniformly between these endpoints. That is to say, various limits and step sizes may be configured or defined per parameter type (e.g., PR, C, P_{d}, Pₒ). Moreover, in some implementations, if the parameters are complex values, the real and imaginary parts may be quantized with same/different ranges and number of steps, according to the parameter distribution.

A possible implementation of the quantization process may be defined as:

$$q \left(x\right) = max \left(- a , min \left(a , x\right)\right) / \left(2 a / \left(q l v l - 1\right)\right) \qquad \text{(11)}$$

or

$$q \left(x\right) = max \left(- a , min \left(a , x\right)\right) / \left(a / \left(q l v l - 1\right)\right) \qquad \text{(12)}$$

where x denotes the quantization indices, a denotes the quantization range and qlvl denotes the quantization level.

In some possible implementations, it may be desirable to select odd values for the quantization levels (i.e., qlvl) to ensure that a quantization point is available at 0, e.g., for double sided parameters, as will be appreciated by the skilled person.

It may be worthwhile to note that, as has already been indicated above, the example of FIG. 1 generally shows an implementation of passive prediction (i.e., the W channel). However, as will be understood and appreciated by the skilled person, in some other possible implementations, an active prediction may be applied. Generally speaking, an active W channel may allow some kind of mixing of at least some of the X, Y, Z channels into the W channel, and such active prediction may typically be used in the case of 1-channel downmix. Accordingly, in passive prediction cases, there would generally be no mixing of X, Y, Z channels into the W channel.

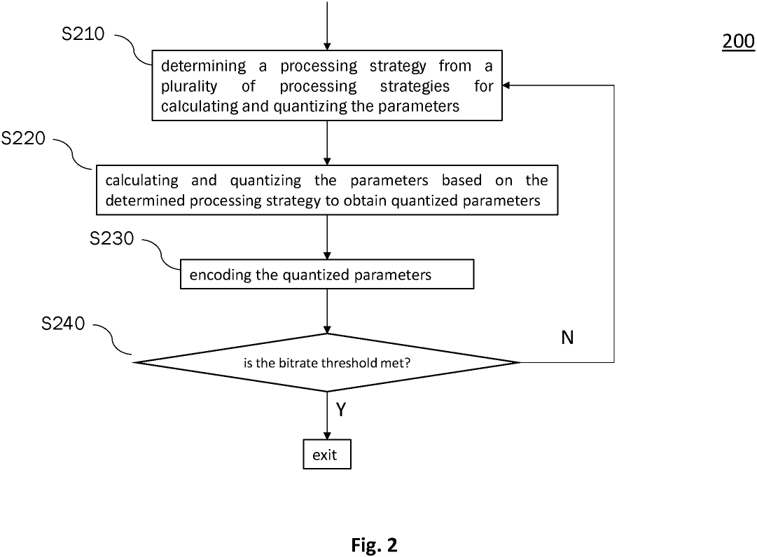

FIG. 2 is a flowchart illustrating an example of a method 200 of frame-wise encoding metadata for an input signal according to an embodiment of the disclosure. The method 200 as described herein may for example be applied to the codec 100 as shown in FIG. 1 (or any other suitable codec). The metadata may be computed/calculated (e.g., extracted) from the input (audio or video) signal by using a suitable codec (coder/decoder). Generally speaking, the metadata may be used to help regeneration of the input signal at the decoder side. The metadata may comprise a plurality of at least partially interrelated parameters that are calculable from the input signal. That is to say, at least some of the parameters of the input signal may be calculated (e.g., generated or regenerated) in dependence on at least some of the other parameters, such that, depending on various circumstances, not all of the parameters have to be always transmitted in plain.

The method 200 may be iteratively performed, e.g., by using a looping process (which will be described in detail below) for each frame of the input signal. In particular, the method 200 (or more precisely, the looping process) starts with step S210 by determining a processing strategy from a plurality of processing strategies for calculating and quantizing the parameters.

Once the processing strategy has been determined (e.g., selected) in step S210, the looping process proceeds to step S220 of calculating and quantizing the parameters based on the determined processing strategy to obtain quantized parameters.

Subsequently in step S230, the (quantized) parameters are encoded accordingly, and then a (resulting) bitrate is estimated (e.g., calculated) from the encoded parameters and a decision is being made based on the estimated bitrate together with at least one target bitrate threshold (e.g., predefined or preconfigured) in step S240.

If the bitrate threshold is met, e.g., the estimated bitrate is equal to or less than the bitrate threshold, the method 200 exits the processing loop. Otherwise, the loop returns back to step S210 and continue with the steps S210 to S240. Particularly, when re-entering the loop, a new processing strategy may be determined, in order to meet the bitrate threshold target.

As can be understood and appreciated by the skilled person, the plurality of processing strategies for calculating and quantizing the parameters may be provided in any suitable manner, such as, predefined or preconfigured. Accordingly, the processing strategy may also be determined, from the plurality of processing strategies, in any suitable manner. For instance, depending on a (current) bitrate requirement, a suitable processing strategy may be selected out of the plurality of processing strategies, such that a resulting bitrate after performing the calculation, quantization and encoding (e.g., with or without entropy coding) based on the so selected processing strategy meets the (current) bitrate requirement.

Since the looping process is generally directed to (among others) the processing relating to quantization, in some cases, the looping process may also be referred to as a quantization loop (or simply loop for short). In a similar manner, since the processing strategy is also generally directed to (among others) the processing relating to quantization, in some cases, the processing strategy may also be referred to as a quantization strategy (or, in some other cases, interchangeably as a quantization scheme). Further, it is to be noted that the encoding process may use any suitable coding procedure including but is not limited to, entropy coding or coding without entropy (e.g., base2 coding). Of course, any other suitable coding mechanism may be adopted depending on various implementations and/or requirements.

Specifically, each one of the plurality of processing strategies may comprise a respective first indication that is indicative of an ordering (or a sequence) related to the calculation and quantization of individual parameters. That is to say, the first indication may comprise sequence information indicating when and in which order the individual parameters are calculated and quantized. As an example (but not as limitation), the first indication may comprise information indicating that all the parameters are calculated first before any of them are being quantized.

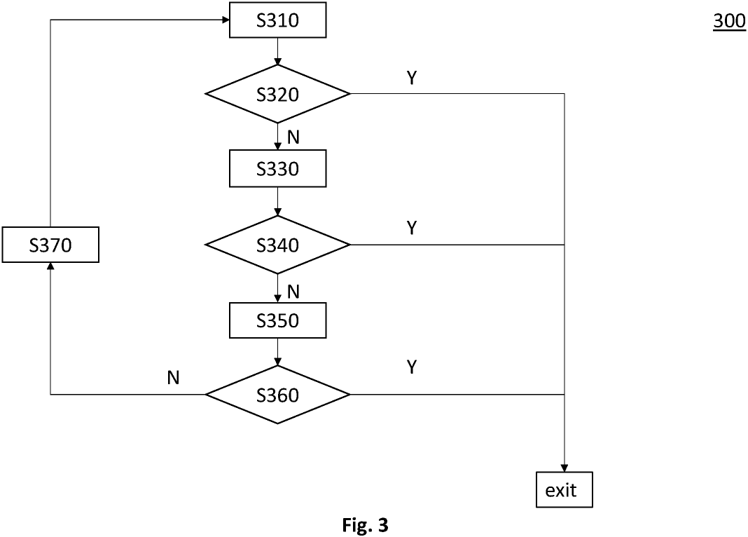

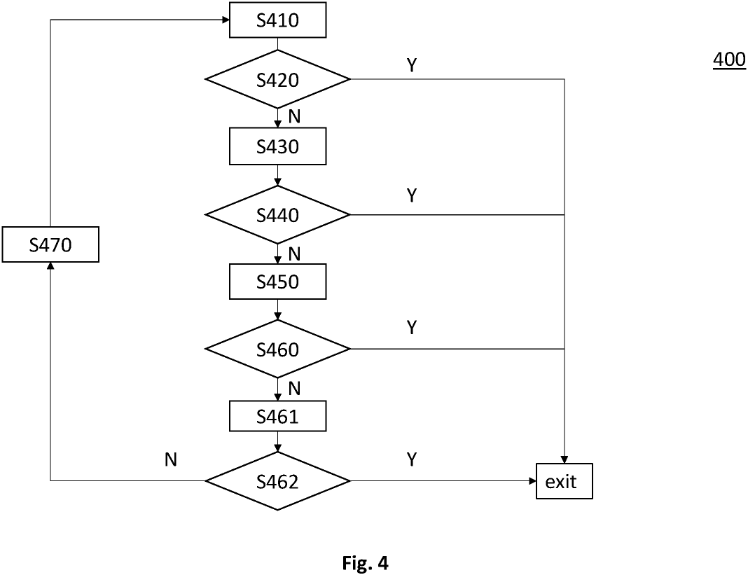

Now the looping process will be described in more detail with reference to the examples as shown in FIGS. 3 and 4.

As indicated above, in codecs with short strides or frame updates, the parameters may be oversampled if they are all included in every frame. Thus, the primary focus of the present disclosure is to propose mechanisms to minimize side information as much as possible, but yet to retain a short frame update rate for the audio essence and parameters.

To address the above issue, particularly to assess the expansion of side information, broadly speaking, the inventor of the present disclosure generally proposes a mechanism of incorporating time-differential estimates for parameters of some (frequency) bands along with non-differential estimates for parameters of other (frequency) bands. The proposed approach interleaves which bands are time-differentially encoded and non-differentially encoded so that every band is regularly refreshed with a non-differential calculation without the need of a full parameter update. The core concept is that as the frame size decreases, then the frame to frame correlation of parameters increases and thus increased coding gains can be made by time-differentially encoding parameters.

In addition to the frequency interleaving of time-differential coding, it is also introduced with the concept of an iterative and stepwise approach to selecting an optimal parameter quantization scheme that searches for a ‘best’ (or optimal) quantization scheme from multiple alternatives. In this case, the term ‘best’ or ‘optimal’ may not necessarily be the quantization scheme with the lowest parameter bit rate, but one which mitigates state for the decoder.

For example, the use of time-differential encoding may generally have the downside primarily in the fact that there is frame to frame state introduced which can present problems when, during transmission, the audio stream might undergo packet loss. In this case, both audio and parameters may be lost and any parameters which are being updated with time-differential coding may experience multiple subsequent frames of potential artefacts. In the present disclosure, the decoder mitigations of said issue are generally not addressed. Instead, the issue is generally addressed (mitigated) by choosing an appropriate quantization scheme which would limit this behavior as much as possible. Broadly speaking, the encode (encoder side) mitigation generally involves an iterative selection process for the quantization and entropy encoding which attempts to minimize the extent to which artefacts arising from packet loss may be introduced due to the use of time-differential coding.

Now referring back to the figures, FIG. 3 is a flowchart schematically illustrating an example of a processing loop 300 according to an embodiment of the disclosure.

The processing loop 300 starts with step S310 where a first bitrate (hereinafter referred to as b1) is calculated (or estimated). In some possible implementations, for every frame, the entropy of the non-differentially and/or frequency-differentially quantized parameters is estimated. In some other possible implementations, the first bitrate b1 may be calculated as the minimum of non-differential and frequency-differential coding schemes coded with (trained) entropy coders (e.g., Huffman or Arithmetic coding).

In step S320, the first bitrate b1 is compared with a target bitrate (hereinafter referred to as t). If the parameter bit rate estimate b1 is within (equal to or less than) the target bitrate t, then the processing loop exits. As a result, the parameters are encoded so that any extra available bits are supplied to the audio encoder to increase the bit rate of the audio essence.

If step S320 fails (i.e., the estimated bitrate b1 is larger than the target bitrate t), then in step S330 a second bit rate (hereinafter referred to as b2) of the quantized parameters is calculated. In some possible implementations, the second bitrate b2 may be calculated in a non-differential manner without entropy coding (e.g., by using base2 coding).

Then in step S340, the second bitrate b2 is compared with the target bitrate t. If the second bitrate b2 is within (equal to or less than) the target bitrate t, the processing loop exits.

Otherwise, a third bit rate (hereinafter referred to as b3) of the parameters is calculated in step S350. In some possible implementations, the third bitrate b3 may be calculated by time-differential coding with the (trained) entropy coders. In some further possible implementations, a subset of parameter values in the current frame may be quantized and then subtracted from the quantized parameter values in the previous frame, and the differential quantized parameter value and entropy may be calculated.

In step S360, if the calculated bitrate b3 is equal to or below the threshold t, then the processing loop exits, and the parameters are encoded with the supplied bitrate and the extra bits are supplied to encode the audio with.

Otherwise, various measures may be implemented in step S370 in order to eventually meet the target bitrate threshold t.

For example, in some possible implementations, a second, coarser processing strategy (quantization strategy) may be selected from the plurality of processing strategies. In such cases, as will be understood and appreciated by the skilled person, the quantization process may include several levels of increasingly coarse quantization such as, for example, fine, moderate, coarse and extra coarse quantization strategies. Then, after determining (e.g., selecting) the coarser quantization strategy, the processing loop repeats the steps of S310 to S360.

In some other possible implementations, a step of reducing the number of frequency bands may be performed in S370. Then the steps (i.e., steps S310 to S360) mentioned above may be repeated with the reduced band configuration. This would generally reduce the total number of parameters to quantize and can often result in a low bit rate for (at least) some frames.

Alternatively or additionally, in yet some further implementations, it may also be possible to perform a step of freezing (i.e., reusing) the parameters in a band from the previous frame. This would basically stop a parameter from changing with time, thereby resulting in reduced entropy for time-differential entropy coding. For example, as displayed in Table 2 (which will be described in detail below), when encoding with coding scheme 4a, then one may freeze parameters in frequency bands 2, 6, and 10. This would typically result is reduced entropy, no change to the decoder or to the entropy coding scheme, and a slight impact to quality. It is to be noted that the above example of 2, 6 and 10 is just an illustrative example, and one can have many band configurations that can be frozen across multiple frames, as will be understood and appreciated by the skilled person. For instance, if one is freezing all frequency bands over a period of 2 frames, then the encoder can send half of the bands in frame N and the remaining half in frame N+1 (thereby reducing the total number of parameters to be sent), which generally means that the decoder will get all (e.g., 12) updated frequency bands every other frame. In such cases, if one frame is lost, there is generally the option of extrapolating from the last two good frames. When recovering from packet loss, it is possible to interpolate between the bands that were received with a given frame.

Notably, if the loop exits at step x, then the final parameter bitrate is the bitrate that is computed at that step x.

Furthermore, in some implementations, it may be possible (or even desirable) to consider designing the bitrate b3 with the coarsest quantization strategy (among the given plurality of quantization strategies available to quantize the parameters) as guaranteed to be less than the target bitrate threshold t. In such cases, it may be guaranteed that there always exists a solution for fitting parameter bitrate within the target bitrate t.

FIG. 4 is a flowchart schematically illustrating an example of a processing loop 400 according to another embodiment of the disclosure. Particularly, identical or like reference numbers in the loop 400 of FIG. 4 generally indicate identical or like elements in the loop 300 as shown in FIG. 3, such that repeated description thereof may be omitted for reasons of conciseness.

In particular, the processing loop of FIG. 4 may be specifically suitable for cases where two bitrate thresholds (represented as a target bitrate threshold t1 and a maximum bitrate threshold t2) are used, as opposed to the single target bitrate threshold scenario as shown in FIG. 3. Broadly speaking, the target bitrate threshold t or t1 may be considered as a target or goal that is good to achieve, whilst the maximum bitrate threshold t2 may be simply seen as the ‘hard’ threshold that should not exceed.

More particularly, the steps S410 to S470 are the same as those (i.e., steps S310 to S370) in FIG. 3, such that repeated description thereof may be omitted for reasons of conciseness.

However, instead of directly switching to step S470 if the condition of S460 fails to be met, an additional step S461 is inserted by computing a fourth bitrate (b4) as the minimum of the bitrate b1, b2 and b3. Then the fourth bitrate b4 is compared with the maximum bitrate threshold t2 in step S462.

If the fourth bitrate b4 is equal to or less than the maximum bitrate threshold t2, the processing loop 400 exits; otherwise, the processing loop 400 continues with step S470 (which is essentially the same as step S370 in FIG. 4) and repeat the steps of S410 to S462.

Similar as FIG. 3, if the loop exits at step x, then the final parameter bitrate is the bitrate that is computed at that step x.

Moreover, in some implementations, it may also be possible (or even desirable) to consider designing the bitrate b3 with the coarsest quantization strategy (among the given plurality of quantization strategies available to quantize the parameters) as guaranteed to be less than the maximum bitrate threshold t2. In such cases, it may be guaranteed that there always exists a solution for fitting parameter bitrate within the maximum bitrate t2.

Summarizing, steps S310, S330 and S350 of FIG. 3 and correspondingly also steps S410, S430 and S450 of FIG. 4 generally have no impact on the audio quality. Step S461 of FIG. 4 would however reduce quality by having an impact on both the audio bit rate and parameter bit rate. Further, any of the possible techniques/mentioned above in step S370 of FIG. 3 and S470 of FIG. 4 (e.g., moving to coarser quantization, band reduction by reducing frequency resolution, band reduction by reducing time resolution, etc.) would basically have a negative impact on quality. Thus, the steps in the examples of FIGS. 3 and 4 are ordered in such a way as to minimize quality degradations or to address constraints in other areas. Broadly speaking, the method as described in the present disclosure tends to choose one or more of the above illustrated techniques to keep the balance between metadata bitrate reduction and perceptual quality.

There are also additional considerations that go into the specific ordering of the above steps and the reason for possibly two target parameter bit rates (i.e., t1 and t2).

In particular, the stepwise ordering allows one to terminate the procedure if the constraints are met. This would generally reduce computational load when calculations are done serially, because one will typically not proceed through all available steps.

Further, the ordering also allows an implicit preference of alternatives. For example, ordering the non-differential entropy coding as the first step would generally mean that this alternative is preferred if it meets the constraints. This is an encoder mitigation to minimize state to improve quality during conditions of packet loss.

Moreover, the possibility of using two targets (t1 and t2) would generally allow the ability to trade off audio bit rate and parameter bit rate with greater control.

Now, description of interleaving to achieve time-differential coding will be described in more detail.

Some possible implementations to manage interleaving of time-differential entropy coding is displayed in Table 2.

TABLE 2

Interleaved time-differential coding schemes

| Coding Scheme | Time Diff Coding, Bands 1-12 |
|---|---|
| base | 000000000000 |
| 4a | 011101110111 |
| 4b | 101110111011 |
| 4c | 110111011101 |
| 4d | 111011101110 |

In this specific example, it is generally proposed 5 configurations for metadata bitstream coding, each of them consisting of 12 (frequency) bands. More particularly, the band specified by 0 is coded non-differentially and the band specified by 1 is coded time-differentially (i.e., quantize the parameter and subtract from the quantized parameter in the previous frame).

As described in the example, the parameter bit rate of each frame is first evaluated by coding non-differentially (i.e., base) by quantizing the parameters (for example see step S410 or S510). Then, at step S450 or S550, the time-differential coding scheme is chosen (if so required) based on the previous frame’s coding scheme.

An example of mapping from previous frame’s coding scheme to current frame’s time-differential coding scheme is shown below in Table 3:

TABLE 3

Mapping of the time-differential coding schemes

| | |
|---|---|
| previous frame’s coding scheme | current frame’s time-differential coding scheme |
| base | 4a |
| 4a | 4b |
| 4b | 4c |
| 4c | 4d |
| 4d | 4a |

Notably, in the present example, the term “base” used in Table 3 generally refers to the non-differential coding scheme. Thus, as can be seen from Table 3, the time-differential coding always cycles through 4a to 4d (and back again). It is possible to continue cycling without ever requiring non-differential coding to be implemented. And in this particular example, the maximum memory or ‘state’ of the codec is the current frame and three past frames (i.e., in total four frames). Of course, as will be understood and appreciated by the skilled person, the numbers of 5 configurations and 12 (frequency) bands etc. are merely used as examples for illustrative purpose, any other suitable number may be used, depending on various implementations and/or requirements. Analogous or similar arguments apply to the switching between coding schemes as shown in Table 3, which may likewise adopt any suitable technique.

Notably, if a different quantization scheme is chosen, then the indices from previous frame quantized with a different quantization scheme may be first mapped to that of the current frame. Generally speaking, the step of mapping may be required to allow time-differential coding of parameters e.g., when the number of quantization levels changes from one frame to the next, thereby allowing time-differential coding between frames without resorting to having to send a non-differential frame each time the quantization scheme is changed.

As a possible example, the mapping of the indices may be performed based on the formulae:

$$\begin{matrix}i n d e {x}_{c u r} = \\ r o u n d \left(i n d e {x}_{p r e v} \times \left(q u a n t \_ l v {l}_{c u r} - 1\right) / \left(q u a n t \_ l v {l}_{p r e v} - 1\right)\right)\end{matrix} \qquad \text{(13)}$$

where index_{cur} denotes the indices of the current frame after mapping, indexₚᵣₑᵥ denotes the indices of the previous frame, quant_lvl_{cur} denotes the quantization level of the current frame and quant_lvlₚᵣₑᵥ denotes the quantization level of the previous frame.

As a simple illustrative example, let the quantization range be 0 to 2, and let the previous quantization levels be 11. In the case of uniform quantization, this would generally mean that each quantization step would be 0.2. Further, let the current quantization levels be 21, which means that each quantization step is 0.1 with uniform quantization. Based on these assumptions, if a quantized value in the previous frame was 0.4, then with 11 uniform quantization levels, one would get the following previous index indexₚᵣₑᵥ = 2. The mapping provides the quantized indices of the previous frame’s metadata as if it were quantized using the current frame’s quantization levels. Thus, in this example, if the quantization levels in the current frame are 21, then the quantized value 0.4 would be mapped to index_{curr} = 4. Once mapped indices are computed, the difference between the current frame and previous frame indices is calculated, and this difference is encoded. Analogous or similar approaches may also be applied to the frequency-differential coding, if needs be, as will be understood and appreciated by the skilled person.

Of course, any other suitable mapping schemes (e.g., by using a lookup table or similar) may be adopted, depending on various implementations and/or requirements.

Moreover, as indicated above, a single metadata parameter may be quantized from a continuous numerical value to an index representing a discrete value. In non-differential coding, the information that is coded for that metadata parameter corresponds directly to that index. In time-differential coding, the information that is coded is the difference between the index of that metadata parameter from the current frame, and the index of the same metadata parameter from the previous frame. As will be understood and appreciated by the skilled person, the above illustrated general concept of time-differential coding may be further extended, e.g., to a plurality of frequency bands. Accordingly, the metadata parameter may be extended similarly, e.g., to a plurality of parameters respectively corresponding to the plurality of frequency bands, as appropriate. Frequency-differential coding follows a similar principle, but the coded difference is between one frequency band’s metadata of the current frame and the other frequency band’s metadata of the current frame (as opposed to the current frame minus the previous frame in time-differential coding). As a simple example (but not as limitation), assuming a0, a1, a2 and a3 denote parameters indices in 4 frequency bands of a particular frame, then, in one example implementation, the frequency-differential indices can be a0, a0-a1, a1-a2, a2-a3. As will be appreciated by the skilled person, the general idea behind the (time- and/or frequency-) differential coding is that metadata may typically change slowly from frame to frame, or from frequency-band to frequency-band, so that even if the original value of the metadata was large, the difference between it and the previous frame’s metadata, or difference between it and other frequency band’s metadata, would likely be small. This is advantageous because, generally, parameters with statistical distributions that tend towards zero can be coded using fewer bits. Thus, even if some of the example implementations might make reference briefly or merely to time-differential coding, the skilled person would appreciate that also frequency-differential coding may be applied thereto (possibly with minor suitable adaption).

Some further possible examples of the present disclosure may relate to a process of processing an input audio signal, represented in sub-bands to produce a down-mixed signal and associated metadata can be performed by one or more processors. The process can include, for each sub-band, determining a down-mix matrix and associated metadata; and remixing each of said sub-bands according to said down-mix matrix to produce said down-mixed signal. One or more quantization strategies and one or more coding strategies can be used to encode the metadata given a target and/or maximum metadata bitrate limitation.

In some implementations, the process can include non-differential entropy coding of all sub-bands. The process can further include frequency-differential entropy coding of all sub-bands. The process can further include combining frequency interleaving with time-differential encoding of quantized parameters corresponding to selected subbands for a low latency audio codec as described in detail above.

The process can further include non-entropy coding of sub-band metadata. Iterating through steps to find an appropriate coding strategy to meet bitrate and audio quality requirements, and to reduce decoder state. The process can further include reducing frequency resolution by reducing the number of subbands in which spatial metadata is to be coded, e.g., 12 bands to 6 bands. The process can include reducing time resolution by time-fixing (or freezing) one or more sub-band metadata, such that a sub-band’s metadata need not be sent. The process can include using of multiple quantization strategies where each strategy is a combination of quantization levels for various spatial metadata parameters, the process can further include choosing between these quantization strategies to ensure that the bitrate targets are met. The process can include iterating through steps to find an appropriate quantization scheme to meet bitrate and audio quality requirements. The iteration method focusing on getting desired metadata bitrate with desired quantization scheme, minimal computational complexity, and reduced decoder state. If the desired quantization level does not fit in the desired bitrate range, then falling back to a (e.g., coarser) quantization scheme by ensuring minimal impact on audio quality.

In some implementations, a mapping of indexes from previous frames quantized to a different number of levels to that of the current frame, allows time-differential coding between frames without resorting to having to send a non-differential frame each time a different quantization level is needed.

In various implementations, the quantization (conversion of continuous values to discrete indices for encoding) can include determining the best value for the coefficients according to the current needs, by manipulating the order of calculation and quantization of successive metadata coefficients.

A computing device implementing the techniques described above can have the following example architecture. Other architectures are possible, including architectures with more or fewer components. In some implementations, the example architecture includes one or more processors (e.g., dual-core Intel® Xeon® Processors), one or more output devices (e.g., LCD), one or more network interfaces, one or more input devices (e.g., mouse, keyboard, touch-sensitive display) and one or more computer-readable mediums (e.g., RAM, ROM, SDRAM, hard disk, optical disk, flash memory, etc.). These components can exchange communications and data over one or more communication channels (e.g., buses), which can utilize various hardware and software for facilitating the transfer of data and control signals between components.

The term “computer-readable medium” refers to a medium that participates in providing instructions to processor for execution, including without limitation, non-volatile media (e.g., optical or magnetic disks), volatile media (e.g., memory) and transmission media. Transmission media includes, without limitation, coaxial cables, copper wire and fiber optics.

Computer-readable medium can further include operating system (e.g., a Linux® operating system), network communication module, audio interface manager, audio processing manager and live content distributor. Operating system can be multi-user, multiprocessing, multitasking, multithreading, real time, etc. Operating system performs basic tasks, including but not limited to: recognizing input from and providing output to network interfaces 706 and/or devices 708; keeping track and managing files and directories on computer-readable mediums (e.g., memory or a storage device); controlling peripheral devices; and managing traffic on the one or more communication channels. Network communications module includes various components for establishing and maintaining network connections (e.g., software for implementing communication protocols, such as TCP/IP, HTTP, etc.).

Architecture can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer or computing system, or similar electronic computing devices, that manipulate and/or transform data represented as physical, such as electronic, quantities into other data similarly represented as physical quantities.

Reference throughout this disclosure to “one example embodiment”, “some example embodiments” or “an example embodiment” means that a particular feature, structure or characteristic described in connection with the example embodiment is included in at least one example embodiment of the present disclosure. Thus, appearances of the phrases “in one example embodiment”, “in some example embodiments” or “in an example embodiment” in various places throughout this disclosure are not necessarily all referring to the same example embodiment. Furthermore, the particular features, structures or characteristics may be combined in any suitable manner, as would be apparent to one of ordinary skill in the art from this disclosure, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the disclosure, various features of the disclosure are sometimes grouped together in a single example embodiment, Fig., or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this disclosure.

Furthermore, while some example embodiments described herein include some but not other features included in other example embodiments, combinations of features of different example embodiments are meant to be within the scope of the disclosure, and form different example embodiments, as would be understood by those skilled in the art. For example, in the following claims, any of the claimed example embodiments can be used in any combination.

In the description provided herein, numerous specific details are set forth. However, it is understood that example embodiments of the disclosure may be practiced without these specific details. In other instances, well-known methods, structures and techniques have not been shown in detail in order not to obscure an understanding of this description.

Thus, while there has been described what are believed to be the best modes of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

Various aspects and implementations of the present disclosure may also be appreciated from the following enumerated example embodiments (EEEs), which are not claims.

EEE 1. A method of processing an input audio signal, represented in sub-bands to produce a down-mixed signal and associated metadata, the method including:
for each sub-band, determining a down-mix matrix and associated metadata; and;
remixing each of said sub-bands according to said down-mix matrix to produce said down-mixed signal.

EEE 2. The method of EEE 1 wherein the metadata is encoded using one or more quantization strategies and one or more coding strategies given a target and/or maximum metadata bitrate limitation.

EEE 3. The method of EEE 2, comprising non-time-differential entropy coding of all sub-bands.

EEE 4. The method of EEE 3, comprising combining frequency interleaving with time-differential encoding of quantized parameters corresponding to selected subbands for a low latency audio codec.

EEE5. The method of EEE 4, comprising non-entropy coding of sub-band metadata.

EEE 6. The method of EEE 5, wherein iterating through step 3) to 5) to find an appropriate coding strategy to meet bitrate and audio quality requirements, and to reduce decoder state.

EEE 7. The method of EEE 6, comprising reducing the number of bands sent by combination of metadata in subbands.

EEE 8. The method of EEE 7, comprising: time-fixing one or more sub-band metadata, such that a sub-band’s metadata need not be sent.

EEE 9. The method of EEE 8, comprising: using multiple quantization levels for the given metadata to ensure that the bitrate targets are met.

EEE 10. The method of EEE 9, wherein iterating through the steps of EEEs 3 to 9 to find an appropriate quantization scheme to meet bitrate and audio quality requirements.

EEE 11. The method of EEE 3 or EEE 9, wherein a mapping of indexes from previous frames quantized to a different number of levels to that of the current frame, allows time-differential coding between frames without resorting to having to send a non-time-differential frame each time a different quantization level is needed.

EEE 12. The method of any of the EEEs above where the quantization includes determining the best value for the coefficients according to the current needs, by manipulating the order of calculation and quantization of successive metadata coefficients.

EEE 13. A system comprising:
one or more processors; and
a non-transitory computer-readable medium storing instructions that, when executed by the one or more processors, cause the one or more processors to perform operations of any of EEEs 1-12.

EEE 14. A non-transitory computer-readable medium storing instructions that, when executed by one or more processors, cause the one or more processors to perform operations of any of EEEs 1-12.

1. A method of frame-wise encoding metadata for an input signal, the metadata comprising a plurality of at least partially interrelated parameters calculable from the input signal, the method comprising, for each frame:
iteratively performing, by using a looping process, steps of:
determining a processing strategy from a plurality of processing strategies for calculating and quantizing the parameters;
calculating and quantizing the parameters based on the determined processing strategy to obtain quantized parameters; and
encoding the quantized parameters,
wherein each of the plurality of processing strategies comprises a respective first indication indicative of an ordering related to the calculation and quantization of individual parameters; and
wherein the processing strategy is determined based on at least one bitrate threshold.

2. The method according to claim 1, wherein the processing strategy is determined such that a bit rate of the encoded quantized parameters is equal to or less than the bitrate threshold.

3. The method according to claim 1, wherein each of the plurality of processing strategies further comprises a respective second indication indicative of information for performing the quantization of the parameters.

4. The method according to claim 3, wherein the information for performing the quantization of the parameters comprises respective quantization ranges or quantization levels for the plurality of parameters.

5. The method according to claim 1, wherein the encoding of the parameters involves time or frequency-differential coding.

6. The method according to claim 1, wherein the processing strategy determined for a current frame is different from the processing strategy determined for a previous frame; and wherein the encoding of the parameters involves time-differential coding across the different processing strategies.

7. The method according to claim 1, wherein the first indication comprises information indicating that all of the parameters are calculated before being quantized.

8. The method according to claim 1, wherein the first indication comprises information indicating that the parameters are individually calculated and then quantized one after another in sequence, and wherein at least one parameter of the plurality of parameters is calculated based on another one or more quantized parameters of the plurality of parameters.

9. The method according to claim 1, wherein the first indication comprises information indicating that all of the parameters are calculated before any parameter is quantized; and wherein at least one of the parameters is recalculated, based on another quantized parameter, and the recalculated parameter is quantized.

10. The method according to claim 6, wherein the method further comprises, before encoding the quantized parameters:
mapping indices of the quantized parameters from the previous frame to that of the current frame.

11. The method according to claim 1, wherein the at least one bitrate threshold comprises a target bitrate threshold, and wherein the looping process includes steps of:
quantizing and encoding the parameters in a non-differential or frequency-differential manner with an entropy coder in accordance with the processing strategy;
estimating a first parameter bitrate for the encoded parameters; and
if the first parameter bitrate is less than or equal to the target bitrate threshold, exiting the looping process.

12. The method according to claim 11, wherein the looping process further includes steps of:
if the first parameter bitrate is larger than the target bitrate threshold: quantizing and encoding the parameters in a non-differential manner with no
entropy in accordance with the processing strategy; estimating a second parameter bitrate for the encoded parameters; and if the second parameter bitrate is less than or equal to the target bitrate threshold,
exiting the looping process.

13. The method according to claim 12, wherein the looping process further includes steps of:
if the second parameter bitrate is larger than the target bitrate threshold: quantizing and encoding the parameters in a time-differential manner with the
entropy coder in accordance with the processing strategy; estimating a third parameter bitrate for the encoded parameters; and if the third parameter bitrate is less than or equal to the target bitrate threshold,
exiting the looping process.

14. The method according to claim 13, wherein the time-differential quantization and encoding is performed on a subset of the parameters in a frequency interleaved manner with respect to a previous frame.

15. The method according to claim 13, wherein the time-differential quantization and encoding is performed by cycling through a number of frequency interleaved time-differential coding schemes, such that, for each cycle, a different subset of the parameters is quantized and encoded time-differentially while the rest parameters are quantized and encoded non-differentially.

16. The method according to claim 13, wherein the determined processing strategy is a first processing strategy, and wherein the looping process further includes:
if the third parameter bitrate is larger than the target bitrate threshold:
determining, from the plurality of processing strategies, a second processing strategy, such that a bitrate by applying the second processing strategy is expected to be less than that of using the first processing strategy; and
repeating the steps of the looping process.

17. The method according to claim 13, wherein the parameters are represented in a first number of frequency bands, and wherein the looping process further includes steps of:
if the third parameter bitrate is larger than the target bitrate threshold:
performing one of:
reducing the number of frequency bands representing the parameters to a second number smaller than the first number, such that a total number of the parameters to be quantized and encoded is reduced; and
reusing parameters in one or more frequency bands from the previous frame in the current frame ; and
repeating the steps of the looping process.

18. (canceled)

19. (canceled)

20. The method according to claim 1, wherein the parameters comprise one or more of: prediction parameters, cross-prediction parameters, and decorrelation parameters.

21. The method according to claim 20, wherein the prediction parameters are calculated and quantized first, the cross-prediction parameters are calculated from the quantized prediction parameters and then quantized, and the decorrelation parameters are calculated from the quantized cross-prediction parameters and the quantized prediction parameters, and then quantized.

22. The method according to claim 20, wherein the parameters are first calculated, then the decorrelation parameters and the prediction parameters are quantized, and, from the quantized prediction parameters, the cross-prediction parameters are recalculated and then quantized.

23. The method according to claim 1, wherein the method is applied to metadata encoding of an immersive voice and audio services, IVAS, codec or an Ambisonics codec.

24. (canceled)

25. An apparatus comprising a processor and a memory coupled to the processor, wherein the processor is adapted to cause the apparatus to carry out a method of frame-wise encoding metadata for an input signal, the metadata comprising a plurality of at least partially interrelated parameters calculable from the input signal, the method comprising, for each frame:
iteratively performing, by using a looping process, steps of:
determining a processing strategy from a plurality of processing strategies for calculating and quantizing the parameters;
calculating and quantizing the parameters based on the determined processing strategy to obtain quantized parameters; and
encoding the quantized parameters,
wherein each of the plurality of processing strategies comprises a respective first indication indicative of an ordering related to the calculation and quantization of individual parameters; and
wherein the processing strategy is determined based on at least one bitrate threshold.

26. A computer-readable storage medium storing a program comprising instructions that, when executed by a processor, cause the processor to carry out a method of frame-wise encoding metadata for an input signal, the metadata comprising a plurality of at least partially interrelated parameters calculable from the input signal, the method comprising, for each frame:
iteratively performing, by using a looping process, steps of:
determining a processing strategy from a plurality of processing strategies for calculating and quantizing the parameters;
calculating and quantizing the parameters based on the determined processing strategy to obtain quantized parameters; and
encoding the quantized parameters,
wherein each of the plurality of processing strategies comprises a respective first indication indicative of an ordering related to the calculation and quantization of individual parameters; and
wherein the processing strategy is determined based on at least one bitrate threshold.

27. (canceled)
